(19) United States
(12) Patent Application Publication
(10) Pub. No.: US 2018/0139732 A1
(43) Pub. Date: May 17, 2018

(54) USER TERMINAL, RADIO BASE STATION, AND RADIO COMMUNICATION METHOD

(71) Applicant: NTT DOCOMO, INC., Tokyo (JP)

(72) Inventors: Kazuki Takeda, Tokyo (JP); Satoshi Nagata, Tokyo (JP); Lihui Wang, Beijing (CN); Liu Liu, Beijing (CN); Huiling Jiang, Beijing (CN)

(73) Assignee: NTT DOCOMO, INC., Tokyo (JP)

(21) Appl. No.: 15/572,855

(22) PCT Filed: May 13, 2016
(86) PCT No.: PCT/JP2016/064240

§ 371 Date: Nov. 9, 2017

(30) Foreign Application Priority Data
May 14, 2015 (JP) 2015-099439

(51) Int. Cl. H04W 72/04; H04L 1/00

(52) U.S. Cl. CPC H04W 72/042; H04W 88/02; H04L 1/0003

(57) ABSTRACT

An aperiodic CSI report is appropriately triggered even when the number of component carriers that can be configured per user terminal is enhanced compared to an existing system. A user terminal includes: a reception section that receives downlink control information including information related to an instruction of transmission of aperiodic channel state information; and a control section that controls the transmission of the aperiodic channel state information, and the control section controls the transmission of the aperiodic channel state information by selecting a first modulation order or a second modulation order according to a number of serving cells and/or an index, where the first modulation order is defined in advance, the second modulation order is equal to or higher than the first modulation order, the serving cells are serving cells for which the transmission of the aperiodic channel state information is instructed, and the index is related to a modulation and coding scheme included in the downlink control information.

### TECHNICAL FIELD

The present invention relates to a user terminal, a radio base station, and a radio communication method of a next-generation communication system.

### BACKGROUND ART

In UMTS (Universal Mobile Telecommunications System) networks, for purposes of higher data rates, lower delay and the like, Long Term Evolution (LTE) has been specified (Non-patent Document 1). Further, for purposes of wider bands and higher speed than LTE, a successor system of LTE that is called LTE Advanced (also referred to as LTE-A) has been studied and specified as LTE Rel.10 to 12.

A system band of LTE Rel.10 to 12 includes at least one Component Carrier (CC) whose one unit is a system band of an LTE system. Aggregating a plurality of CCs and widening a band in this way are referred to as Carrier Aggregation (CA).

Further, in case of LTE according to Rel. 8 to 12, an exclusive operation in a frequency band licensed to a business operator, i.e., in a licensed band has been assumed and specified. For example, licensed bands such as 800 MHz, 2 GHz or 1.7 GHz are used.

According to LTE of Rel.13 or subsequent versions, an operation in a frequency band that does not need to be licensed, i.e., in an unlicensed band has also been studied as a target. For example, a 2.4 GHz or 5 GHz band that is same band as that of Wi-Fi is used as the unlicensed band. According to Rel.13 LTE, carrier aggregation (LAA: Licensed-Assisted Access) between a licensed band and an unlicensed band is a target to study yet dual connectivity or stand-alone of an unlicensed band is also likely to be a target to study in future.

### CITATION LIST

### Non-Patent Literature

[Non-Patent Literature 1] 3GPP TS 36.300 “Evolved Universal Terrestrial Radio Access (E-UTRA) and Evolved Universal Terrestrial Radio Access Network (E-UTRAN); Overall description; Stage 2”

### SUMMARY OF INVENTION

### Technical Problem

According to carrier aggregation of LTE Rel.10 to 12, the number of component carriers that can be configured per user terminal is limited to five at maximum. According to carrier aggregation of LTE Rel.13 and subsequent versions, enhancing the number of component carriers that can be configured per user terminal to six or more to realize further band extension has been studied.

When the number of CCs that can be configured per user terminal is enhanced to six or more (e.g. 32), it is difficult to apply a transmitting method of an existing system (Rel.10 to 12) as is. For example, the existing system supports an aperiodic CSI report for transmitting Channel State Information (CSI) from a user terminal according to a transmission instruction from a radio base station.

However, the existing system assumes that the number of cells (CCs) is five or less. Hence, there is a concern that, when the number of CCs is enhanced to six or more and the method of the existing system is used as is, there is a concern that it is not possible to appropriately trigger an aperiodic CSI report according to the enhanced number of CCs.

The present invention has been made in view of such a respect, and it is an object of the invention to provide a user terminal, a radio communication system and a radio communication method for appropriately triggering an aperiodic CSI report even when the number of component carriers that can be configured per user terminal is enhanced compared to an existing system.

One aspect of a user terminal according to the present invention includes: a reception section that receives downlink control information including information related to an instruction of transmission of aperiodic channel state information; and a control section that controls the transmission of the aperiodic channel state information, and the control section controls the transmission of the aperiodic channel state information by selecting a first modulation order or a second modulation order according to a number of serving cells and/or an index, where the first modulation order is defined in advance, the second modulation order is equal to or higher than the first modulation order, the serving cells are serving cells for which the transmission of the aperiodic channel state information is instructed, and the index is related to a modulation and coding scheme included in the downlink control information.

According to the present invention, it is possible to appropriately trigger an aperiodic CSI report even when the number of component carriers that can be configured per user terminal is enhanced compared to an existing system.

### BRIEF DESCRIPTION OF DRAWINGS

FIG. 1 is an explanatory diagram of carrier aggregation;

FIG. 2 is an explanatory diagram of a table of a two-bit A-CSI trigger;

FIG. 3 is a diagram illustrating an example of a table that defines a correspondence between indices and modulation orders of a modulation and coding scheme;

FIG. 4 is a diagram illustrating an example of a method for determining a modulation order according to Aspect 1;

FIG. 5 is a diagram illustrating an example of a table that defines a correspondence between MCS indices and modulation orders;

FIG. 6 is an explanatory diagram of an example of an aperiodic CSI report according to Aspect 2;

FIGS. 7 contain explanatory diagrams of a table of an A-CSI trigger according to Aspect 2;

FIG. 8 is a diagram illustrating an example of a schematic configuration of a radio communication system according to this Embodiment;

FIG. 9 is a diagram illustrating an example of an entire configuration of a radio base station according to this Embodiment;

FIG. 10 is a diagram illustrating an example of a function configuration of the radio base station according to this Embodiment;

FIG. 11 is a diagram illustrating an example of an entire configuration of a user terminal according to this Embodiment; and

FIG. 12 is a diagram illustrating an example of a function configuration of the user terminal according to this Embodiment.

### DESCRIPTION OF EMBODIMENTS

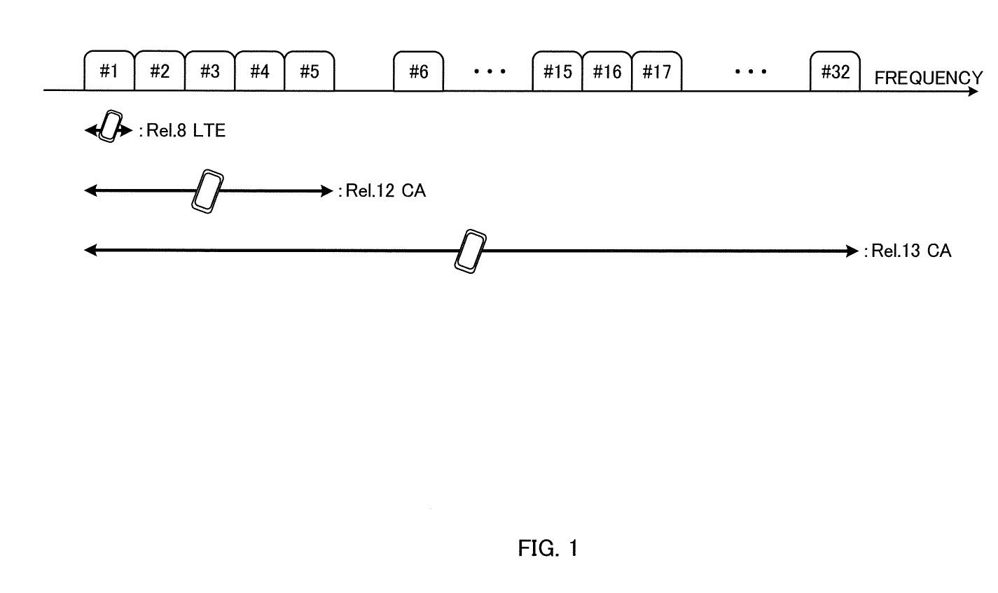

FIG. 1 is an explanatory diagram of Carrier Aggregation (CA). As illustrated in FIG. 1, according to CA up to LTE Rel.12, five Component Carriers (CC) at maximum (CC #1 to CC #5) whose one unit is a system band according to LTE Rel.8 are bundled. That is, according to the carrier aggregation up to LTE Rel.12, the number of CCs that can be configured per user terminal (UE: User Equipment) is limited to five at maximum.

Meanwhile, according to carrier aggregation of LTE Rel.13 and subsequent versions, it is considered to bundle six or more CCs to further expand a band. That is, according to carrier aggregation of LTE Rel.13, it is considered to enhance the number of CCs that can be configured per user terminal to six or more (CA enhancement). For example, as illustrated in FIG. 1, when 32 CCs (CC #1 to CC #32) are bundled, if 20 MHz is allocated to one CC, it is possible to secure a band of 640 MHz at maximum.

Thus, it is expected to realize more flexible and high-speed radio communication by enhancing the number of CCs that can be configured per user terminal. Further, enhancing the number of CCs in this way is effective to widen a band according to carrier aggregation (LAA: License-Assisted Access) between a licensed band and an unlicensed band. When, for example, five CCs (=100 MHz) in a licensed band and 15 CCs (=300 MHz) in an unlicensed band are bundled, it is possible to secure a band of 400 MHz.

In an unlicensed band for which LAA is operated, introduction of an interference control function is studied to enable coexistence with LTE, Wi-Fi or other systems of other business operators. LBT (Listen Before Talk) based on CCA (Clear Channel Assessment) is studied as the interference control function. Consequently, cells (CCs) that use the unlicensed band can be cells, too, that listening (LBT and the like) is applied to.

By the way, LTE Rel.10 to 12 support an aperiodic CSI report for transmitting Channel State Information (CSI) from a user terminal according to a transmission instruction from a radio base station. The transmission instruction (referred to as an A-CSI trigger below) from the radio base station includes an uplink scheduling grant (referred to as an UL grant (Uplink Grant) below) transmitted on a downlink control channel (PDCCH: Physical Downlink Control Channel).

According to the aperiodic CSI (A-CSI) report, the user terminal transmits CSI by using an uplink shared channel (PUSCH: Physical Uplink Shared Channel) specified by the UL grant according to the A-CSI trigger included in the UL grant. In this regard, the CSI transmitted according to the A-CSI trigger may be referred to as aperiodic CSI (A-CSI). This CSI includes at least one of a Channel Quality Indicator (CQI), a Precoding Matrix Indicator (PMI), and a Rank Indicator (RI).

According to the A-CSI report, a CSI request field (A-CSI trigger) included in the UL grant can include one bit or two bits. For example, it is possible to transmit a one-bit ACI-trigger by using a DCI format 0 and transmit a two-bit A-CI trigger by using a DCI format 4.

According to the one-bit A-CSI trigger, whether or not to transmit CSI is instructed. When, for example, a value of the A-CSI trigger takes “0”, not transmitting CSI is instructed and, when the value takes “1”, transmitting the CSI of a serving cell that transmits a PUSCH is instructed. Meanwhile, according to the two-bit A-CSI trigger, whether or not to transmit the CSI and, in addition, CSI of which serving cell is transmitted are instructed. Carrier aggregation of LTE Rel.10 to 12 supports the two-bit A-CSI trigger.

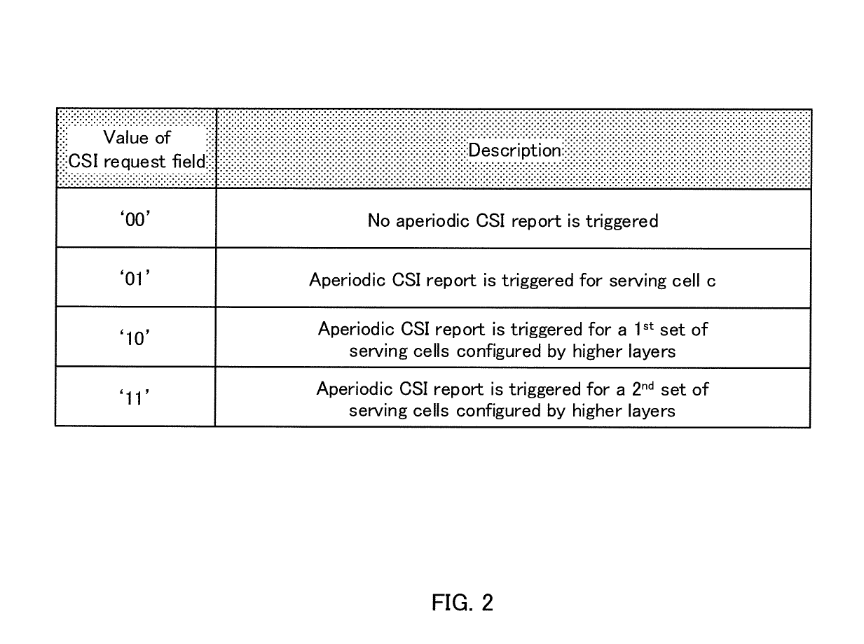

FIG. 2 is an explanatory diagram of an example of the two-bit A-CSI trigger. When, for example, a value of the A-CSI trigger (CSI Request field) is “00” in FIG. 2, not transmitting CSI is instructed and, when the value is “01”, transmitting the CSI of a serving cell (CC) that transmits the PUSCH is instructed. Further, when this values is “10” or “11”, transmitting CSI of a first serving cell set (1^{st} set) and a second serving cell set (2^{nd} set) is instructed.

A serving cell combination (serving cell set) refers to a set of serving cells, and is configured by at least one serving cell. In FIG. 2, a radio base station can notify in advance a user terminal of information indicating serving cells configuring the first and second serving cell sets by higher layer signaling such as RRC signaling.

Further, the radio base station can include information related to a modulation and coding scheme applied by the user to PUSCH transmission, in downlink control information, and can notify the user terminal of the downlink control information. For example, the radio base station can notify the user terminal of a predetermined index (also referred to as an MCS index or an I_{HCS}) by using a bit field (Modulation and coding scheme and redundancy version) related to a modulation coding scheme and the like configured to the downlink control information (UL grant).

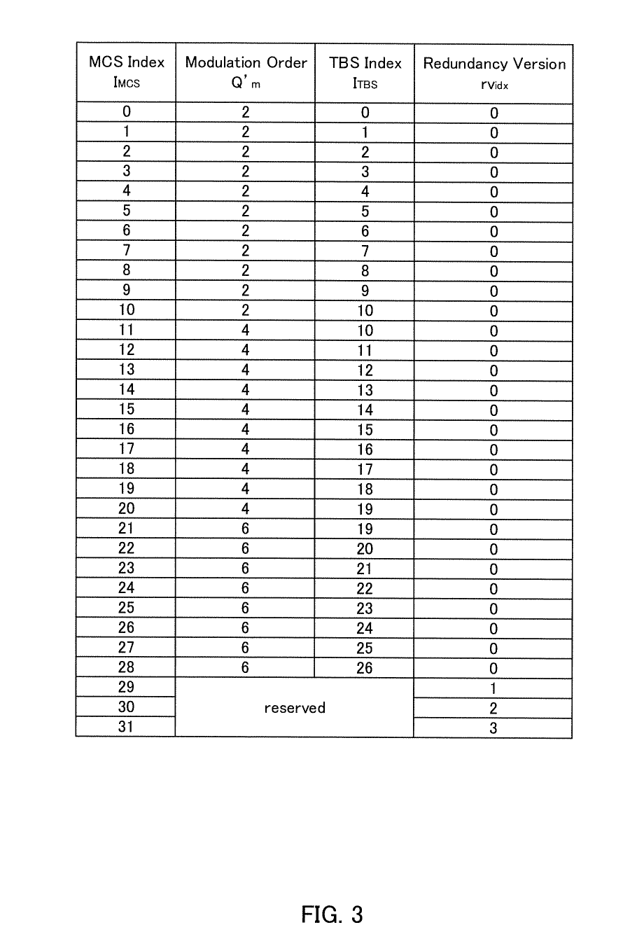

The user terminal can apply a predetermined modulation scheme based on a modulation order associated with the MCS index (I_{MCS}), and control transmission of an uplink shared channel (PUSCH). Further, the user terminal can control PUSCH transmission by using a table that defines each MCS index, each modulation order applied to PUSCH transmission and the like (see FIG. 3). The user terminal applies QPSK when the modulation order is 2(Qₘ=2), applies 16 QAM when the modulation order is 4(Qₘ=4) and applies 64 QAM when the modulation order is 6(Qₘ=6).

When, for example, each of MCS indices is 0 to 28 (0≤I_{MCS}≤28), the user terminal controls PUSCH transmission by referring to the table in FIG. 3 and using the modulation order (modulation scheme) and the like associated with each MCS index. When each of the MCS indices 0 to 28 is notified, the user terminal controls a data signal (UL-SCH) by using the modulation order associated with each MCS index. Thus, in an existing system, MCS indices 29 to 31 are reserved for a data signal.

Further, in the existing system, when the MCS index is 29 (I_{MCS}=29), a modulation order and the like applied to A-CSI transmission using a PUSCH is defined in a fixed manner. That is, when only the A-CSI is transmitted without concurrently multiplexing the A-CSI and a data signal (UL-SCH) on the PUSCH, I_{MCS}=29 is used. More specifically, the definition is made as follows.

When the I_{MCS} of a DCI format 0 is 29 or an I_{MCS} of a DCI format 4 that only one transport block (one TB) is configured to is 29, and when one of following (a) to (c) applies, a modulation order is configured to 2(Qₘ=2).

(a) A case where a CSI request field includes one bit, an A-CSI report is triggered and the number of PRBs is four or less,
(b) a case where a CSI request field includes two bits, an A-CSI report for one serving cell is triggered and the number of PRBs is four or less, or
(c) a case where a CSI request field includes two bits, an A-CSI report for two or more serving cells is triggered and the number of PRBs is 20 or less

Thus, Rel.12 and previous versions assume CA that support five CCs at maximum, and therefore a modulation order (modulation scheme) and the maximum number of PRBs (Physical Resource Blocks) that the user terminal can use to transmit A-CSI on the PUSCH are limited. When, for example, the user terminal transmits A-CSI without transmitting a data signal (UL-SCH) (UCI on PUSCH without UL-SCH), a modulation order (Qₘ=2)/modulation scheme (QPSK) defined in advance in a fixed manner are configured. Further, when A-CSI of a plurality of CCs is transmitted, the maximum number of PRBs (N_{PRB}) that can be used for A-CSI transmission is 20 or less.

However, when the number of CCs that can be configured per user terminal is enhanced to six or more (e.g. 32 CCs), if the modulation order and/or the number of PRBs applied to A-CSI transmission are limited, there is a concern that it is not possible to appropriately transmit the A-CSI associated with the enhanced number of CCs.

When, for example, CSI per CC is assumed to include 72 bits, the CSI includes 360 bits in total for five CCs. When 20 PRBs are used for A-CSI transmission, one PRB is 18 bits. Meanwhile, when the A-CSI corresponding to 32 CCs is reported under the same assumption, the A-CSI includes 2304 bits in total, and one PRB is 116 bits. This means that the number of bits transmitted by using the identical resources is six times or more compared to five CCs.

Thus, when an A-CSI report is triggered by a configuration where the number of CCs is enhanced to six or more by using a method of an existing system (Rel.12 or previous versions), there is a concern that it is not possible to appropriately trigger the A-CSI report as the number of CCs configured to the user terminal increases.

Hence, the inventors of the present invention have conceived controlling a modulation order and/or the number of allocated PRBs applied to transmission of an A-CSI report based on predetermined conditions (e.g. the number of cells for reporting the A-CSI) when cells (CCs) are enhanced compared to the existing system.

When, for example, the number of cells for which A-CSI report is triggered is a predetermined number (e.g. five cells) or less, a first modulation order (first modulation scheme) defined in advance in a fixed manner is applied. Meanwhile, when the number of cells for which the A-CSI report is triggered is larger than a predetermined value, transmission of the A-CSI using a second order (modulation scheme) equal to or higher than the first modulation order and/or the number of PRBs larger than a predetermined number is permitted. The second modulation order can be configured to be dynamically or semi-statically changed.

Alternatively, when the user terminal is notified of a first index (e.g. the I_{MCS} is 29), the first modulation order (first modulation scheme) defined in advance in a fixed manner is applied. Meanwhile, when the user terminal is notified of an MCS index (e.g. the I_{MCS} is 30 or 31) that is not used by the existing system, transmission of the A-CSI using the second modulation order equal to or higher than the first modulation order and/or the number of PRBs larger than a predetermined value may be permitted.

Further, the inventors of the present invention have conceived securing flexibility of an A-CSI report corresponding to the enhanced number of CCs by increasing types of serving cells indicated by an A-CSI trigger when the number of CCs that can be configured per user terminal is enhanced to six or more.

This Embodiment will be described in detail below. An example where the number of CCs that can be configured per user terminal during CA will be described below. However, this Embodiment is not limited to this. Further, the following configuration is suitably applicable to a case where A-CSI is transmitted (e.g. UCI on PUSCH without UL-SCH) without allocating uplink data (UL-SCH) to the PUSCH. This Embodiment is not limited to this. Further, a case where MCS indices are used as indices notified to the user terminal will be described below. However, this Embodiment is not limited to this. It is also possible to use indices different from the MCS indices.

### (Aspect 1)

Aspect 1 describes a case where A-CSI transmission using a predetermined modulation order and/or frequency resources of PRBs larger than a predetermined number (e.g. 20 PRBs) is permitted for a user terminal satisfying predetermined conditions. The predetermined modulation order (modulation scheme) can be, for example, a modulation order (a modulation scheme equal to or higher than 16 QAM) whose Qₘ is four or more.

A radio base station can configure to the user terminal according to Rel.13 or subsequent versions a plurality of cells equal to or more than six cells as a cell set (1^{st} set and/or 2^{nd} set) defined in the table in FIG. 2, and notify the user terminal of the cell set.

The user terminal may report to the radio base station in advance the number of CCs that can be included in a cell set as UE capability information. In this case, the number of CCs that can be included in the cell set may differ per frequency band type (e.g. a licensed frequency and an unlicensed frequency) or may be defined per user terminal irrespective of a frequency band. As long as the number of CCs that differs per frequency band type can be included in the cell set, it is possible to perform an operation of, for example, applying an A-CSI report to a licensed frequency similar to conventional CA and include more CCs in a CSI set in an unlicensed frequency, and it is possible to more efficiently operate the unlicensed frequency of a wider band.

Meanwhile, by determining the number of CCs included in a cell set per user terminal irrespective of a frequency band type, it is possible to reduce an information amount included in the UE capability information reported by the user terminal, and reduce an overhead. The number of CCs may differ according to, for example, whether or not a frequency requires Listen-Before-Talk (LBT) irrespective of a frequency band type.

Further, the number of CCs that can be included in a cell set may differ according to an information amount of CSI reported by using A-CSI. For example, wideband CSI of a small information amount may enable more CCs to be included in a cell set, and a narrow band CSI of a large information amount may enable less CCs to be included in a cell set. The maximum number of CCs that can be included in these cell sets may be reported in advance as the UE capability information from the user terminal to the radio base station in every case, and CCs included in a cell set actually configured to the user terminal may be notified to a UE by higher layer signaling.

Further, the base station can notify the user terminal of information related to an A-CSI transmission instruction by using a CSI request field of downlink control information (e.g. a DCI format 0 or 4 which is an UL grant). The user terminal controls A-CSI transmission based on the A-CSI transmission instruction (A-CSI trigger) transmitted from the radio base station. When the CSI request field indicates “10” (or “11”), the user terminal allocates the A-CSI of a plurality of cells (e.g. six cells or more) configured as the 1^{st} set (or 2^{nd} set) to the PUSCH to transmit.

Further, the user terminal can determine a modulation order (modulation scheme) applied to A-CSI transmission based on an MCS index (I_{MCS}) specified in a bit field related to the number of CCs for which A-CSI transmission is instructed and/or a modulation coding scheme. For example, A-CSI transmission using a predetermined modulation scheme and/or frequency resources larger than 20 PRBs can be permitted for the user terminal satisfying the predetermined conditions.

The predetermined conditions include that (1) CA that uses a predetermined number of cells or more is configured, (2) an A-CSI report of a predetermined number of cells or more is instructed and (3) a cell that supports an unlicensed frequency band is configured as a SCell. The predetermined number of cells or more can be, for example, six cells (six CCs). A case where the A-CSI report of the predetermined number of cells or more is instructed is a case where six cells or more are configured as a cell set defined by “10” or “11” in the table in FIG. 2.

The radio base station can control the modulation order and/or the number or PRBs applied to the A-CSI according to whether or not the user terminal satisfies the predetermined conditions. For example, the radio base station can control an A-CSI report operation of the user terminal by notifying the user terminal that satisfy the predetermined conditions of a predetermined MCS index (I_{MCS}) that is not used by the existing system. The user terminal can select a predetermined modulation order based on higher layer signaling and/or downlink control information (e.g. I_{MCS}) instead of a modulation order defined in advance when notified of the predetermined MCS index (e.g. I_{MCS} is 30 or 31).

In this Embodiment, an A-CSI transmission operation of the user terminal can be defined as follows. In this regard, a case where the user terminal selects a modulation order to be applied by using different methods will be described below.

<Notifying Method 1 Using Higher Layer Signaling>

According to a notifying method 1 by higher layer signaling, a radio base station can be configured to notify a user terminal that satisfies the predetermined conditions of a predetermined MCS index (I_{MCS}=30 or 31) and of information related to a modulation order by higher layer signaling.

In this case, when the MCS index is 29 (I_{MCS}=29), the user terminal uses a modulation order/modulation scheme (Qₘ=2/QPSK) defined in advance similar to the existing system, and/or an allowable maximum number of PRBs. Meanwhile, when the MCS index is a predetermined value (e.g. I_{MCS}=30 or 31), the user terminal can control A-CSI transmission by using the modulation order and/or the allowable maximum number of PRBs (e.g. a predetermined number larger than 20 PRBs) notified by higher layer signaling. For example, a user terminal operation can be defined as follows.

When an I_{MCS} of the DCI format 0 is 29 or an I_{MCS} of the DCI format 4 that only one transport block (one TB) is configured to is 29, and when one of following (a) to (c) applies, a modulation order is configured to 2(Qₘ=2).

(a) a case where a CSI request field includes one bit, an A-CSI report is triggered and the number of PRBs is four or less,
(b) a case where a CSI request field includes two bits, an A-CSI report for one serving cell is triggered and the number of PRBs is four or less, or
(c) a case where a CSI request field includes two bits, an A-CSI report for two or more serving cells is triggered and the number of PRBs is 20 or less

When the I_{MCS} of the DCI format 0 is 30 or when the I_{MCS} of the DCI format 4 that only one transport block (one TB) is configured to is 30, and when one of following (d) to (g) applies, a modulation order is configured by higher layer signaling.

(d) a case where a CSI request field includes one bit, an A-CSI report is triggered and the number of PRBs is four or less,
(e) a case where a CSI request field includes two bits, an A-CSI report for one serving cell is triggered and the number of PRBs is four or less,
(f) a case where a CSI request field includes two bits, an A-CSI report for two or more and five or less serving cells is triggered and the number of PRBs is 20 or less, or
(g) a case where a CSI request field includes two bits, an A-CSI report for six or more serving cells is triggered and the number of PRBs is a predetermined number (e.g. 100) or less

Thus, according to the notifying method 1 by using the higher layer signaling, when a predetermined MCS index (e.g. I_{MCS}=30 or 31) that is not used by the existing system is notified by downlink control information, the user terminal determines to apply a predetermined modulation order notified by the higher layer signaling, and can control A-CSI transmission. Consequently, even when an A-CSI report is triggered in a configuration where the number of CCs is enhanced to six or more, the user terminal can appropriately report the A-CSI.

<Notifying Method 2 Using Higher Layer Signaling>

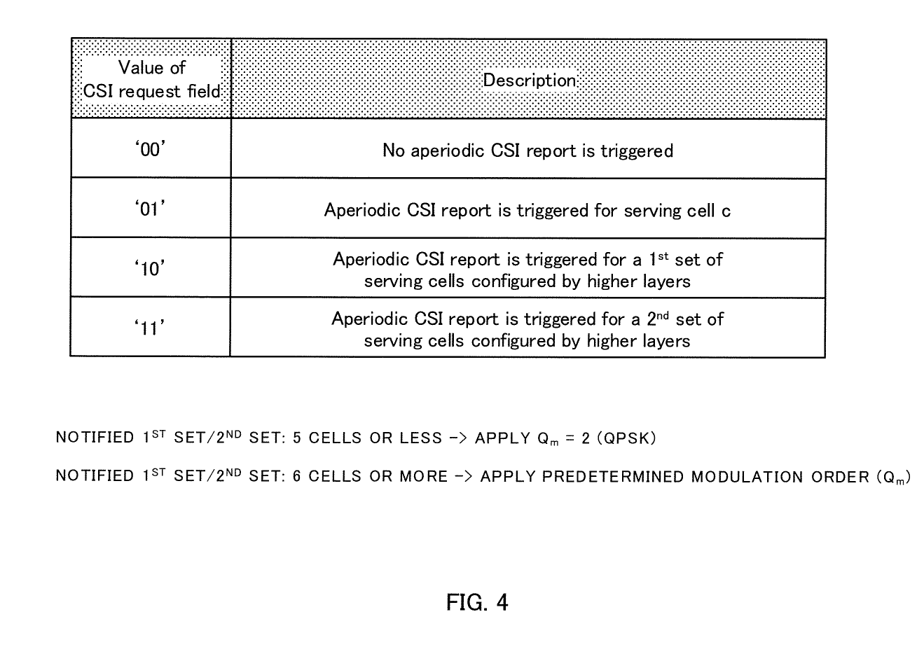

According to a notifying method 2 by higher layer signaling, only when the number of cells for which A-CSI transmission is instructed is larger than a predetermined value (e.g. six cells), a user terminal is configured to apply a predetermined modulation scheme notified by the higher layer signaling (see FIG. 4). For example, a user terminal operation can be defined as follows.

When an I_{MCS} of the DCI format 0 is 29 or when an I_{MCS} of the DCI format 4 that only one transport block (one TB) is configured to is 29 and when one of following (a) to (c) applies, a modulation order is configured to 2(Qₘ=2).

(a) a case where a CSI request field includes one bit, an A-CSI report is triggered and the number of PRBs four or less,
(b) a case where a CSI request field includes two bits, an A-CSI report for one serving cell is triggered and the number of PRBs is four or less, or
(c) a case where a CSI request field includes two bits, an A-CSI report for two or more serving cells is triggered and the number of PRBs is 20 or less

When an I_{MCS} of the DCI format 0 is 30 or an I_{MCS} of the DCI format 4 that only one transport block (one TB) is configured to is 30, and when following (d) applies, a modulation order is configured by higher layer signaling.

(d) a case where a CSI request field includes two bits, an A-CSI report for six or more serving cells is triggered and the number of PRBs is a predetermined number (e.g. 100) or less

Thus, when the number of cells for which A-CSI transmission is instructed is five or less, the user terminal uses a modulation order/modulation scheme (Qₘ=2/QPSK) defined in advance similar to the existing system. Meanwhile, when the number of cells is larger than five, the user terminal uses a modulation order/modulation scheme notified by higher layer signaling instead of a modulation order defined in a fixed manner (see FIG. 4). The modulation order/modulation scheme notified by the higher layer signaling is, for example, 16 QAM and 64 QAM. Further, it is possible to use QPSK depending on the number of cells and/or the number of PRBs to use.

Alternatively, when an MCS index (I_{MCS}=29) used by the existing system is used (above (a) to (c)), above (d) may be configured to be added. In this case, it is possible to employ a configuration of applying a modulation order defined in advance in a case of one of (a) to (c) and applying a modulation order notified by the higher layer signaling in a case of (d).

<Notifying Method 1 Using I_{MCS}>

According to a notifying method 1 by using an I_{MCS}, a radio base station notifies a user terminal of a predetermined MCS index (e.g. I_{MCS}=29 to 31). When an MCS index is 29 (I_{MCS}=29) and the number of serving cells for which A-CSI transmission is instructed is a predetermined value or less, a modulation order defined in advance and/or the number of PRBs equal to or less than a predetermined number are applied.

Meanwhile, when an MCS index is a predetermine value (e.g. an I_{MCS} is 29, 30 or 31) and the number of serving cells for which A-CSI transmission is instructed is larger than a predetermined value, the user terminal can apply a modulation order associated with the MCS index.

In this case, the user terminal determines a modulation order applied to uplink data (UL-SCH) similar to the existing system by using I_{MCS}=0 to 28 (first index group) among a plurality of MCS indices (I_{MCS}=0 to 31) that can be specified in a bit field related to a modulation and coding scheme. Meanwhile, the user terminal can be configured to determine a modulation order applied to A-CSI by using I_{MCS}=29 to 31 (second index group). For example, a user terminal operation can be defined as follows.

When an I_{MCS} of the DCI format 0 is 29 or an I_{MCS} of the DCI format 4 that only one transport block (one TB) is configured to is 29, and when one of following (a) to (c) applies, a modulation order is configured to 2(Qₘ=2).

(a) a case where a CSI request field includes one bit, an A-CSI report is triggered and the number of PRBs is four or less,
(b) a case where a CSI request field includes two bits, an A-CSI report for one serving cell is triggered and the number of PRBs is four or less, or
(c) a case where a CSI request field includes two bits, an A-CSI report for two or more serving cells is triggered and the number of PRBs is 20 or less

When an I_{MCS} of the DCI format 0 is 29 to 31 or an I_{MCS} of the DCI format 4 that only one transport block (one TB) is configured to is 29 to 31, and when following (d) applies, a modulation order associated with the I_{MCS} is configured. (d) a case where a CSI request field includes two bits, an A-CSI report for six or more serving cells is triggered and the number of PRBs is a predetermined number (e.g. 100) or less

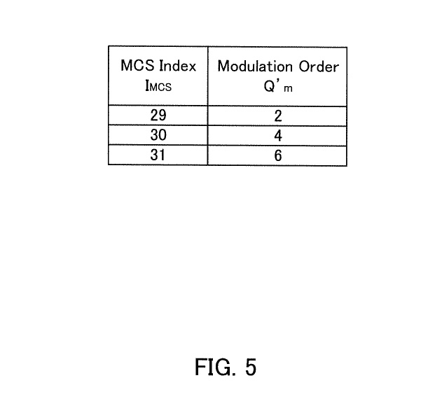

Correspondences between MCS indices and modulation orders can be defined in a table (MCS table) (see FIG. 5). In this case, when an MCS index included in downlink control information is 29 to 31, the user terminal can determine a modulation order applied to the A-CSI based on the notified MCS index and the table in FIG. 5.

Thus, when the number of cells for which A-CSI transmission is instructed is five or less, the user terminal uses a modulation order/modulation scheme (Qₘ=2/QPSK) defined in advance similar to the existing system. Meanwhile, when the number of cells is larger than five, the user terminal uses a modulation order/modulation scheme associated with a predetermined MCS index instead of a modulation order defined in a fixed manner. Modulation orders/modulation schemes associated with MCS indices are a plurality of modulation orders/modulation schemes equal to or higher than Qₘ=2 (QPSK). Thus, even when an A-CSI report is triggered according to a configuration where the number of CCs is enhanced to six or more, the user terminal can appropriately report the A-CSI.

<Notifying Method 2 Using I_{MCS}>

According to a notifying method 2 by using an I_{MCS}, a modulation order (e.g. a modulation order corresponding to an I_{MCS}=0 to 28) applied to uplink data (UL-SCH) is applied as a modulation order applied to A-CSI transmission.

A radio base station can notify a user terminal that satisfies the predetermined conditions of an MCS index (e.g. I_{MCS}=30 or 31) that is not used by the existing system. When an MCS index included in downlink control information (UL grant) is a predetermined value (I_{MCS}=29), the user terminal uses a modulation order/modulation scheme (Qₘ=2/QPSK) defined in advance similar to the existing system.

Meanwhile, when an MCS index included in the downlink control information (UL grant) is a predetermined value (I_{MCS}=30 or 31), the user terminal can control A-CSI transmission by using a modulation order associated with the latest MCS index among indices of the first index group included in the downlink control information that has already been received. In this regard, the first index group can be configured by the indices 0 to 28. For example, a user terminal operation can be defined as follows.

When an I_{MCS} of the DCI format is 29 or an I_{MCS} of the DCI format 4 that only one transport block (one TB) is configured to is 29, and when one of following (a) to (c) applies, a modulation order is configured to 2(Qₘ=2).

(a) a case where a CSI request field includes one bit, an A-CSI report is triggered and the number of PRBs is four or less,
(b) a case where a CSI request field includes two bits, an A-CSI report for one serving cell is triggered and the number of PRBs is four or less, or
(c) a case where a CSI request field includes two bits, an A-CSI report for two or more serving cells is triggered and the number of PRBs is 20 or less.

When an I_{MCS} of the DCI format 0 is 30 or an I_{MCS} of the DCI format 4 that only one transport block (one TB) is configured to is 30, and when one of following (d) to (g) applies, a modulation order associated with an index included in the lastly received first index group in the downlink control information that has already been received is configured.

(d) a case where a CSI request field includes one bit, an A-CSI report is triggered and the number of PRBs is four or less,
(e) a case where a CSI request field includes two bits, an A-CSI report for one serving cell is triggered and the number of PRBs is four or less,
(f) a case where a CSI request field includes two bits, an A-CSI report for two or more and five or less serving cells is triggered and the number of PRBs is 20 or less, or
(g) a case where a CSI request field includes two bits, an A-CSI report for six or more serving cells is triggered and the number of PRBs is a predetermined number (e.g. 100) or less

When a higher modulation order is used, it is possible to perform more efficient transmission and reduce the amount of radio resources necessary to transmit the same information amount. Except in high speed movement environment, a channel state does not significantly fluctuate in subframe units. Hence, it is highly probable that the user terminal that performs communication in environment in which a high modulation scheme can be used can use the same modulation scheme when transmitting A-CSI immediately after, too. Consequently, by applying to A-CSI transmission a modulation order applied to latest uplink data (UL-SCH) transmission, it is possible to reduce a signaling overhead for newly specifying a modulation scheme and report A-CSI according to an appropriate modulation scheme.

In this regard, when an I_{MCS} included in the downlink control information is 30, only the condition (g) may be configured without configuring the conditions (d) to (g).

(Aspect 2)

Aspect 2 describes a method for notifying a user terminal of serving cells for which A-CSI transmission is instructed.

When the user terminal is instructed to transmit A-CSI of cells (e.g. six cells or more) larger than a predetermined number, a plurality of cells is configured by using a combination (cell set) of cells defined in the table in FIG. 2. However, according to the A-CSI trigger illustrated in FIG. 2, serving cell sets of two types indicated by the values “10” and “11” notified by higher layer signaling can be used to instruct CSI transmission.

When, for example, the number of CCs that can be configured per user terminal is enhanced to 32, it is assumed to allocate serving cells of 16 CCs (CCs #1 to #16 for the first serving cell set and CCs #17 to #32 for the second serving cell) to each of the first and second serving cell sets indicated by the values “10” and “11” of the A-CSI trigger. However, in such a case, a radio base station needs to instruct CSI transmission of the first serving cell sets (CC #1 to CC #16) by using the value “10” of the A-CSI trigger even though the radio base station needs to instruct CSI transmission of four serving cells of CC #1 to CC #4 or eight serving cells of CC #1 to CC #8. Therefore, there is a concern that flexibility of an A-CSI report undermines.

Hence, this Embodiment employs a configuration where a maximum number of serving cells which configure each serving cell set is limited to a predetermined value (e.g. eight) or less, and a different cell set is applied based on a serving cell (e.g. SCell cell index or the like) that has received an A-CSI transmission instruction.

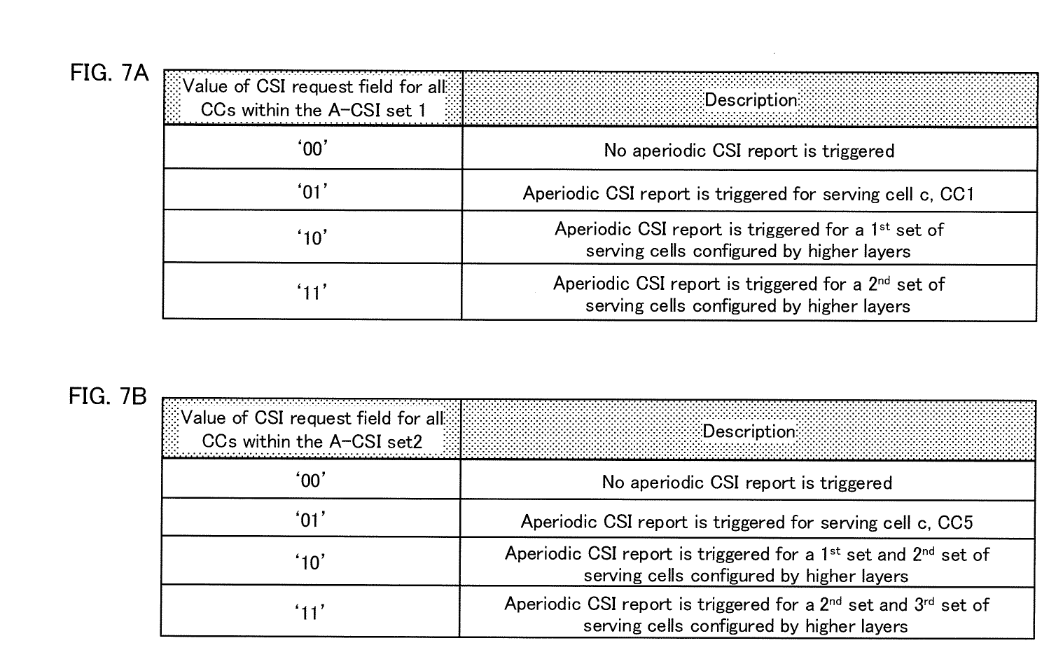

A case where each cell set is configured by four cells (4 CCs) will be described as an example below. The following description assumes a case where the first set (1^{st} set) is configured by CC 1 to CC 4, the second set (2^{nd} set) is configured by CC 5 to CC 8 and the third set (3^{rd} set) is configured by CC 9 to CC 12. Further, a case is assumed where, when the cells that configure the first set receive an A-CSI transmission instruction, the table in FIG. 7A is used and, when the cells that configure the second set receive the A-CSI transmission instruction, a table in FIG. 7B is used. In this regard, the number of CCs that configure a cell set and a combination of CCs are not limited to these.

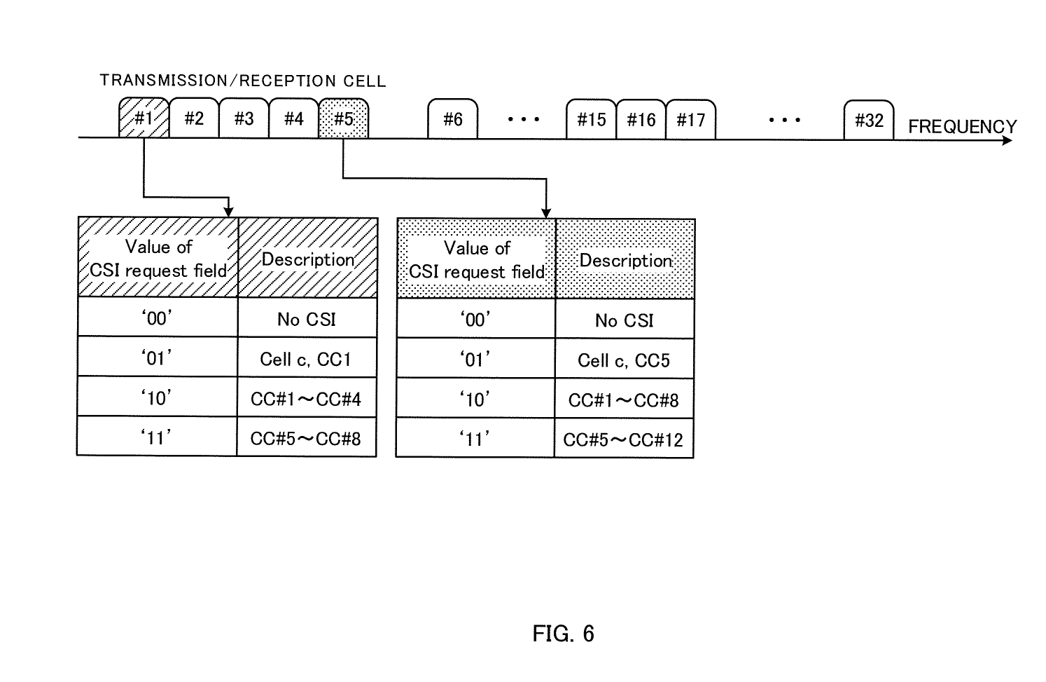

The user terminal can read the cell sets indicated by the values “10” and “11” of the A-CSI trigger based on the serving cells that have received A-CSI transmission instruction information. For example, a case is assumed where a cell (CC 1 herein) belonging to the first set receives an UL grant including the A-CSI trigger. In this case, when a value of the A-CSI trigger is 10, the user terminal interprets the A-CSI trigger as a CSI transmission instruction of the serving cell set of the first set (CC #1 to CC #4) (see FIGS. 6 and 7A). Further, when a value of the A-CSI trigger is 11, the user terminal interprets the A-CSI trigger as a CSI transmission instruction of the serving cell set of the second set (CC #5 to CC #8) (see FIGS. 6 and 7A).

Furthermore, when a cell (CC 5 herein) belongs to the second set receives the UL grant including the A-CSI trigger, and when the value of the A-CSI trigger is “10”, the user terminal interprets the A-CSI trigger as a CSI transmission instruction of serving cell sets of the first set (CCs #1 to CC #4) and the second set (CCs #5 to #8) (see FIGS. 6 and 7B). When the value of the A-CSI trigger is “11”, the user terminal interprets the A-CSI trigger as a CSI transmission instruction of serving cell sets of the second set (CCs #5 to #8) and the third set (CCs #9 to #12).

FIG. 7B illustrates that cell sets indicated by the values “10” and “11” of the A-CSI trigger are read as a plurality of sets. A network (e.g. radio base station) notifies the user terminal of information that associates serving cells (CC), a value of the A-CSI trigger and a serving cell set by higher layer signaling such as RRC signaling. When a given serving cell receives an UL grant including the A-CSI trigger, the user terminal reads a CSI transmission instruction of which serving cell set (one or a plurality of sets) the value of the A-CSI trigger corresponds to, based on the information notified by the higher layer signaling.

Thus, even when the values of the A-CSI trigger included in the UL grants are the same (e.g. “10”), the user terminal interprets the A-CSI trigger as CSI transmission instructions of different serving cells according to a serving cell that has received (detected) the UL grant. Consequently, when uplink carrier aggregation is configured, it is possible to increase the number of serving cell sets for which CSI can be reported without increasing the number of bits of an A-CSI trigger. As a result, even when the number of CCs (the number of serving cells) that can be configured per user terminal is enhanced to six or more, it is possible to secure flexibility of an A-CSI report.

In this regard, the value “10” of the A-CSI trigger may be defined similar to the existing system in the table illustrated in FIG. 7. In this case, the user terminal transmits A-CSI of a serving cell that has transmitted an UL grant including an A-CSI trigger. Further, the user terminal can interpret the table in FIG. 7 based on a type of a serving cell that transmits A-CSI instead of a serving cell that has received (detected) an UL grant.

### (Radio Communication System)

A configuration of a radio communication system according to one Embodiment of the present invention will be described below. A radio communication method according to the above Embodiment of the present invention is applied to this radio communication system. In this regard, the radio communication method according to each of the above Aspects may be applied alone or may be applied in combination.

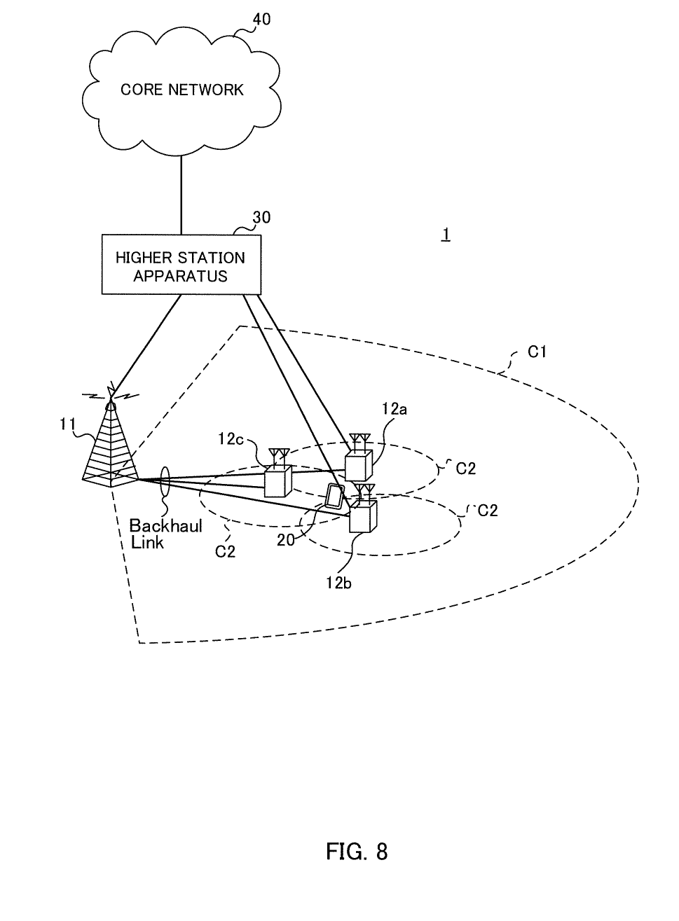

FIG. 8 is a diagram illustrating an example of a schematic configuration of the radio communication system according to one Embodiment of the present invention. In the radio communication system, it is possible to apply Carrier Aggregation (CA) to aggregate a plurality of base frequency blocks (component carriers) whose one unit is a system bandwidth (e.g. 20 MHz) of an LTE system, and/or Dual Connectivity (DC). In this regard, a radio communication system 1 may be called SUPER 3G, LTE-A (LTE-Advanced), IMT-Advanced, 4G, 5G or FRA (Future Radio Access).

The radio communication system 1 illustrated in FIG. 8 includes a radio base station 11 that forms a macro cell C1, and radio base stations 12a to 12c that are located in the macro cell C1 and form small cells C2 narrower than the macro cell C1. Further, a user terminal 20 is located in the macro cell C1 and each small cell C2.

The user terminal 20 can connect to both of the radio base station 11 and the radio base stations 12. The user terminal 20 is assumed to concurrently use the macro cell C1 and the small cells C2 that use different frequencies according to CA or DC. Further, the user terminal 20 can apply CA or DC by using a plurality of cells (CCs) (e.g. six or more CCs).

The user terminal 20 and the radio base station 11 can communicate by using a carrier (existing carrier that is called Legacy carrier) of a narrow bandwidth in a relatively low frequency band (e.g. 2 GHz). Meanwhile, the user terminal 20 and each radio base station 12 may use a carrier of a wide bandwidth in a relatively high frequency band (e.g. 3.5 GHz or 5 GHz) or may use the same carrier as that used by the radio base station 11. In this regard, a configuration of a frequency band used by each radio base station is not limited to this.

The radio base station 11 and each radio base station 12 (or the two radio base stations 12) can be configured to be connected by wires (e.g. optical fibers compliant with a CPRI (Common Public Radio Interface) or an X2 interface) or by radio.

The radio base station 11 and each radio base station 12 are connected to a higher station apparatus 30 and are connected to a core network 40 via the higher station apparatus 30. In this regard, the higher station apparatus 30 includes, for example, an access gateway apparatus, a Radio Network Controller (RNC), a Mobility Management Entity (MME) and the like, but is not limited thereto. Further, each radio base station 12 may be connected to the higher station apparatus 30 via the radio base station 11.

In this regard, the radio base station 11 is a radio base station having relatively wide coverage, and may be referred to as a macro base station, an aggregate node, an eNB (eNodeB) and a transmission/reception point. Further, each radio base station 12 is a radio base station having local coverage, and may be referred to as a small base station, a micro base station, a pico base station, a femto base station, a HeNB (Home eNodeB), a RRH (Remote Radio Head) and a transmission/reception point. The radio base stations 11 and 12 will be collectively referred to as the radio base station 10 unless distinguished below.

Each user terminal 20 is a terminal that supports various communication schemes such as LTE and LTE-A, and may include not only a mobile communication terminal but also a fixed communication terminal.

The radio communication system 1 applies OFDMA (Orthogonal Frequency-Division Multiple Access) to downlink and SC-FDMA (Single Carrier-Frequency Division Mutliple Access) to uplink as a radio access scheme. OFDMA is a multicarrier transmission scheme of dividing a frequency band into a plurality of narrow frequency bands (subcarriers), mapping data on each subcarrier and performing communication. SC-FDMA is a single carrier transmission scheme of dividing a system bandwidth into a band of one or continuous resource blocks, using different bands for a plurality of terminals and reducing an interference between terminals. In this regard, uplink and downlink radio access schemes are not limited to a combination of these.

The radio communication system 1 uses a downlink shared channel (PDSCH: Physical Downlink Shared Channel), a broadcast channel (PBCH: Physical Broadcast Channel) and a downlink L1/L2 control channel shared by each user terminal 20 as downlink channels. User data, higher layer control information and a SIB (System Information Block) are transmitted on the PDSCH. Further, a MIB (Master Information Block) is transmitted on the PBCH.

The downlink L1/L2 control channel includes a PDCCH (Physical Downlink Control Channel), an EPDCCH (Enhanced Physical Downlink Control Channel), a PCFICH (Physical Control Format Indicator Channel), and a PHICH (Physical Hybrid-ARQ Indicator Channel). Downlink Control Information (DCI) including scheduling information of the PDSCH and the PUSCH is transmitted on the PDCCH. The number of OFDM systems used for the PDCCH is transmitted on the PCFICH. A transmission acknowledgement signal (ACK/NACK) of HARQ for the PUSCH is transmitted on the PHICH. The EPDCCH is subjected to frequency division multiplexing with the PDSCH (downlink shared data channel) and is used to transmit a DCI similar to the PDCCH.

The radio communication system 1 uses an uplink shared channel (PUSCH: Physical Uplink Shared Channel), an uplink control channel (PUCCH: Physical Uplink Control Channel) and a random access channel (PRACH: Physical Random Access Channel) shared by each user terminal 20 as uplink channels. User data and higher layer control information are transmitted on the PUSCH. Further, downlink radio quality information (CQI: Channel Quality Indicator) and a transmission acknowledgement signal are transmitted on the PUCCH. A random access preamble for establishing connection with cells is transmitted on the PRACH.

<Radio Base Station>

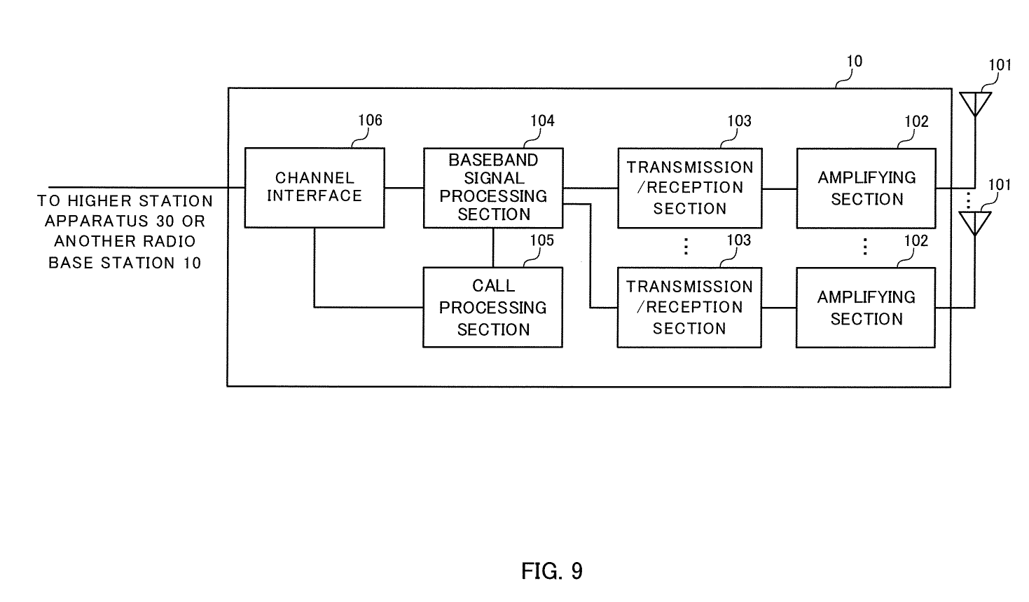

FIG. 9 is a diagram illustrating an example of an entire configuration of the radio base station according to one Embodiment of the present invention. The radio base station 10 includes a plurality of transmission/reception antennas 101, amplifying sections 102, transmission/reception sections 103, a baseband signal processing section 104, a call processing section 105, and a channel interface 106. In this regard, the radio base station 10 need to be configured to include one or more transmission/reception antennas 101, amplifying sections 102 and transmission/reception sections 103.

User data transmitted from the radio base station 10 to the user terminal 20 on downlink is input from the higher station apparatus 30 to the baseband signal processing section 104 via the channel interface 106.

The baseband signal processing section 104 performs processing of a PDCP (Packet Data Convergence Protocol) layer, segmentation and concatenation of the user data, transmission processing of a RLC (Radio Link Control) layer such as RLC retransmission control, and MAC (Medium Access Control) retransmission control (such as transmission processing of HARQ (Hybrid Automatic Repeat reQuest)), and transmission processing such as scheduling, transmission format selection, channel coding, Inverse Fast Fourier Transform (IFFT) processing, and precoding processing on the user data to transfer to each transmission/reception section 103. Further, the baseband signal processing section 104 performs transmission processing such as channel coding and inverse fast Fourier transform on a downlink control signal, too, to transfer to each transmission/reception section 103.

Each transmission/reception section 103 converts a baseband signal precoded and output per antenna from each baseband signal processing section 104, into a signal of a radio frequency band. Each amplifying section 102 amplifies the radio frequency signal subjected to frequency conversion by each transmission/reception section 103, and transmits the radio frequency signal from the transmission/reception antennas 101. Each transmission/reception section 103 can be composed of a transmitter/receiver, a transmission/reception circuit or a transmission/reception device described based on a common knowledge in a technical field of the present invention. In this regard, each transmission/reception section 103 may be composed of an integrated transmission/reception section or may be composed of a transmission section and a reception section.

Meanwhile, each amplifying section 102 amplifies a radio frequency signal as an uplink signal received by each transmission/reception antenna 101. Each transmission/reception section 103 receives the uplink signal amplified by each amplifying section 102. Each transmission/reception section 103 performs frequency conversion on the received signal into a baseband signal, and outputs the baseband signal to the baseband signal processing section 104.

The baseband signal processing section 104 performs Fast Fourier Transform (FFT) processing, Inverse Discrete Fourier Transform (IDFT) processing, error correcting decoding, reception processing of MAC retransmission control, and reception processing of a RLC layer and a PDCP layer on user data included in the input uplink signal to transfer to the higher station apparatus 30 via the channel interface 106. The call processing section 105 performs call processing such as configuration and release of a communication channel, state management of the radio base station 10, and management of radio resources.

In this regard, each transmission/reception section 103 transmits a downlink signal including uplink transmission power control information generated by a transmission signal generating section 302 described below and PHR configuration information to the user terminal 20.

The channel interface 106 transmits and receives signals to and from the higher station apparatus 30 via a predetermined interface. Further, the channel interface 106 may transmit and receive (backhaul signaling) signals to and from the neighboring radio base station 10 via an inter-base station interface (e.g. optical fibers compliant with the CPRI (Common Public Radio Interface) or the X2 interface).

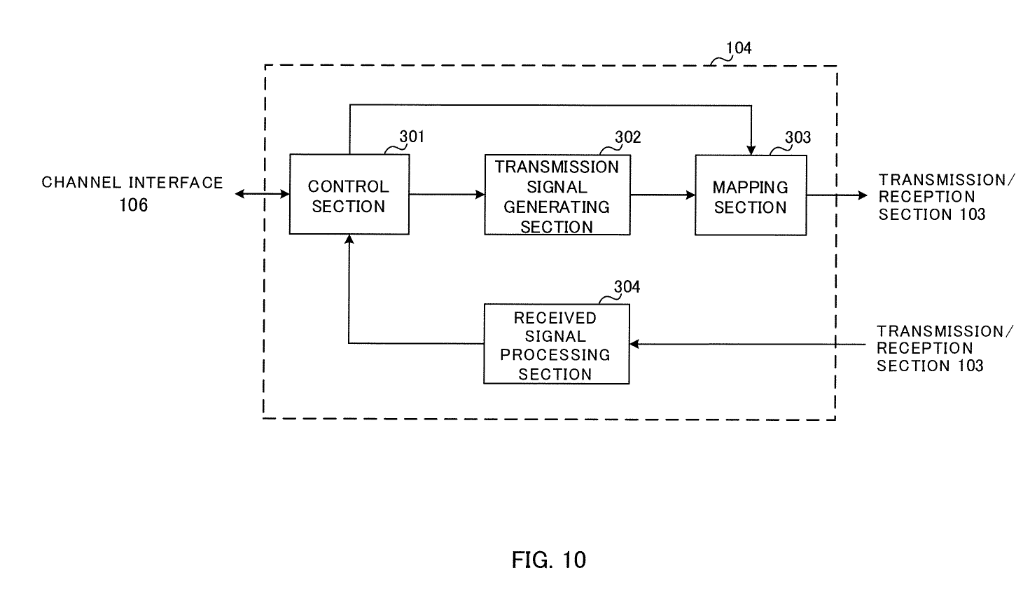

FIG. 10 is a diagram illustrating a function configuration of the radio base station according to this Embodiment. In addition, FIG. 10 mainly illustrates function blocks of characteristic portions in this Embodiment, and it is assumed that the radio base station 10 has other function blocks required for radio communication. As shown in FIG. 10, the baseband signal processing section 104 includes at least a control section (scheduler) 301, a transmission signal generating section 302, a mapping section 303, and a received signal processing section 304.

The control section (scheduler) 301 controls the entire radio base station 10. The control section 301 can be composed of a controller, a control circuit and a control apparatus described based on the common knowledge in the technical field according to the present invention.

The control section 301 controls, for example, generation of signals in the transmission signal generating section 302 and allocation of signals in the mapping section 303. Further, the control section 301 controls reception processing of signals in the received signal processing section 304 and signal measurement.

The control section 301 controls scheduling (e.g. resource allocation) of system information, a downlink data signal transmitted on the PDSCH, and a downlink control signal transmitted on the PDCCH and/or the EPDCCH. Further, the control section 301 controls scheduling of synchronization signals and downlink reference signals such as a CRS (Cell-specific Reference Signal), a CSI-RS (Channel State Information Reference Signal), and a DM-RS (Demodulation Reference Signal).

Furthermore, the control section 301 controls scheduling of an uplink data signal transmitted on the PUSCH, an uplink control signal (e.g. transmission acknowledgement signal (HARQ-ACK)) transmitted on the PUCCH and/or the PUSCH, a random access preamble transmitted on the PRACH and an uplink reference signal. Still further, the control section 301 controls the transmission signal generating section 302 and the mapping section 303 to transmit uplink data of the user terminal 20 that connects to the radio base station 10.

Moreover, the control section 301 can instruct the user terminal to transmit A-CSI of a single cell of a plurality of cells. For example, the control section 301 performs control to configure a plurality of cells equal to or more than six cells as a cell set (the 1^{st} set and/or the 2^{nd} set) defined in the tables in FIGS. 2 and 4 to notify the user terminal. Further, the control section 301 instructs the transmission signal generating section 302 to include information related to an A-CSI transmission instruction in a CSI request field of downlink control information (e.g. the DCI format 0 or 4 that is an UL grant). In this regard, the control section 301 can limit the number of CCs that can be configured per cell set and notify the user terminal of the number of CCs (Aspect 2).

The transmission signal generating section 302 generates a downlink signal (such as a downlink control signal, a downlink data signal and a downlink reference signal) based on an instruction from the control section 301, and outputs the downlink signal to the mapping section 303. The transmission signal generating section 302 can be composed of a signal generator, a signal generation circuit and a signal generating apparatus described based on the common knowledge in the technical field according to the present invention.

The transmission signal generating section 302 generates, for example, a DL assignment for notifying allocation information of a downlink signal, and UL grant for notifying allocation information of an uplink signal based on the instruction from the control section 301. For example, the transmission signal generating section 302 generates the UL grant including information related to an A-CSI transmission instruction. Further, the transmission signal generating section 302 configures a bit field related to a modulation and coding scheme, to the downlink control information and configures a predetermined MCS index (I_{MCS}). It is possible to control a predetermined MCS index based on the number of cells for which A-CSI transmission is instructed for the user terminal.

Further, the transmission signal generating section 302 performs coding processing and modulation processing on a downlink data signal according to a code rate and a modulating scheme determined based on channel state information (CSI) and the like from each user terminal 20.

The mapping section 303 maps the downlink signal generated by the transmission signal generating section 302, on predetermined radio resources based on the instruction from the control section 301, and outputs the downlink signal to the transmission/reception section 103. The mapping section 303 can be composed of a mapper, a mapping circuit or a mapping apparatus described based on the common knowledge in the technical field according to the present invention.

The received signal processing section 304 performs reception processing (e.g. demapping, demodulation and decoding) on a received signal input from each transmission/reception section 103. In this regard, the received signal is, for example, an uplink signal (such as an uplink control signal, an uplink data signal and an uplink reference signal) transmitted from the user terminal 20. The received signal processing section 304 can be composed of a signal processor, a signal processing circuit or a signal processing apparatus described based on the common knowledge in the technical field according to the present invention.

The received signal processing section 304 outputs information decoded by the reception processing to the control section 301. Further, the received signal processing section 304 can perform measurement related to the received signal. That is, the received signal processing section 304 can be composed of a measurement instrument, a measurement circuit or a measurement apparatus described based on the common knowledge in the technical field according to the present invention.

The received signal processing section 304 may measure, for example, received power (e.g. RSRP (Reference Signal Received Power)), received quality (e.g. RSRQ (Reference Signal Received Quality)) or a channel state of the received signal. The received signal processing section 304 may output a measurement result to the control section 301.

<User Terminal>

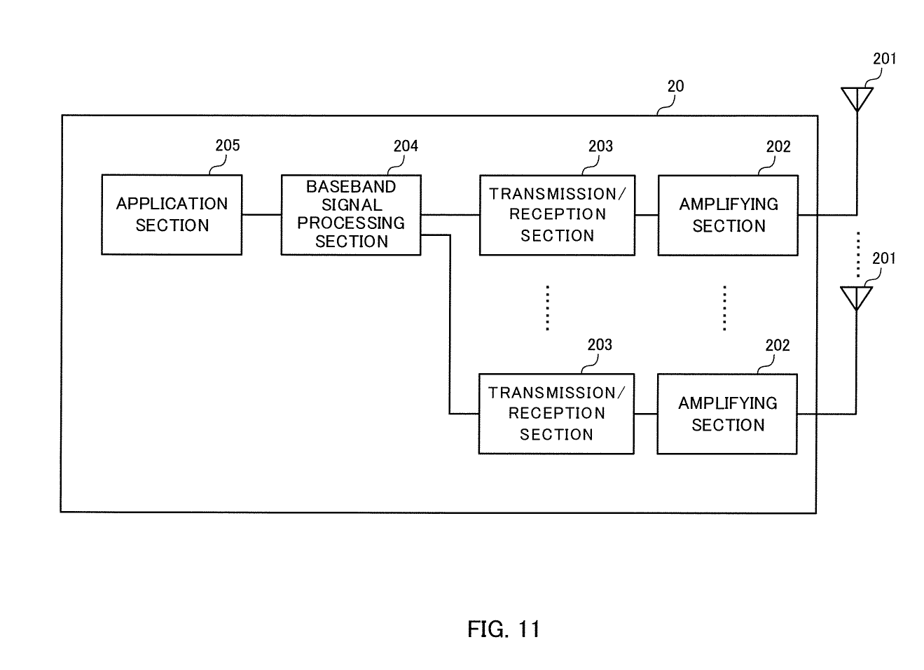

FIG. 11 is a diagram illustrating an example of an entire configuration of the user terminal according to this Embodiment. The user terminal 20 includes a plurality of transmission/reception antennas 201, amplifying sections 202, transmission/reception sections 203, baseband signal processing sections 204, and an application section 205. In this regard, the user terminal 20 needs to be configured to include one or more transmission/reception antennas 201, amplifying sections 202 and transmission/reception sections 203.

Each amplifying section 202 amplifies a radio frequency signal received at each transmission/reception antenna 201. Each transmission/reception section 203 receives a downlink signal amplified by each amplifying section 202. Each transmission/reception section 203 performs frequency conversion on the received signal into a baseband signal, and outputs the baseband signal to the baseband signal processing section 204. The transmission/reception section 203 can be composed of a transmitter/receiver, a transmission/reception circuit or a transmission/reception apparatus described based on the common knowledge in the technical field according to the present invention. In this regard, each transmission/reception section 203 may be composed of an integrated transmission/reception section or may be composed of a transmission section and a reception section.

The transmission/reception section 203 receives the information related to the A-CSI transmission instruction, and transmits A-CSI. Further, the transmission/reception section 203 receives an index (I_{MCS}) specified in a bit field related to a modulation and coding scheme of downlink control information.

The baseband signal processing section 204 performs FFT processing, error correcting decoding, reception processing of retransmission control and the like on the input baseband signal. The baseband signal processing section 204 transfers downlink user data to the application section 205. The application section 205 performs processing concerning layers higher than a physical layer and a MAC layer. Further, the baseband signal processing section 204 transfers broadcast information among the downlink data, too, to the application section 205.

Meanwhile, the application section 205 inputs uplink user data to the baseband signal processing section 204. The baseband signal processing section 204 performs transmission processing of retransmission control (e.g. HARQ transmission processing), channel coding, precoding, Discrete Fourier Transform (DFT) processing, Inverse Fast Fourier Transform (IFFT) processing and the like on the uplink user data to transfer to each transmission/reception section 203. The transmission/reception section 203 converts the baseband signal output from the baseband signal processing section 204 into a signal of a radio frequency band to transmit. Each amplifying section 202 amplifies the radio frequency signal subjected to the frequency conversion by each transmission/reception section 203 to transmit from each transmission/reception antenna 201.

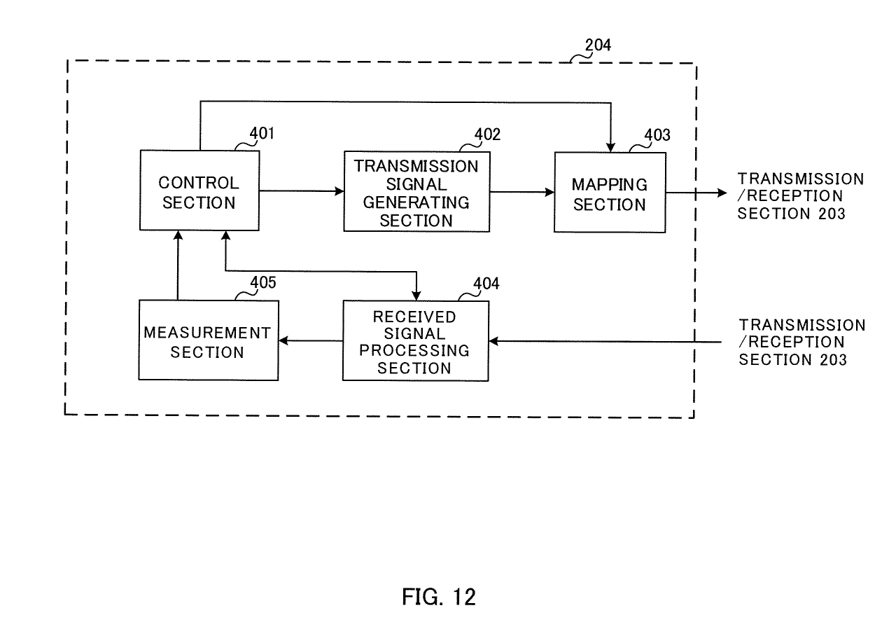

FIG. 12 is a diagram illustrating an example of a function configuration of the user terminal according to this Embodiment. In addition, FIG. 12 mainly illustrates function blocks of characteristic portions in this Embodiment, and it is assumed that the user terminal 20 has other function blocks required for radio communication. As shown in FIG. 12, the baseband signal processing section 204 of the user terminal 20 is configured to include at least a control section 401, a transmission signal generating section 402, a mapping section 403, a received signal processing section 404, and a measurement section 405.

The control section 401 controls the entire user terminal 20. The control section 401 can be composed of a controller, a control circuit or a control apparatus described based on the common knowledge in the technical field according to the present invention.

The control section 401 controls, for example, generation of signals in the transmission signal generating section 402 and allocation of signals in the mapping section 403. Further, the control section 401 controls reception processing of signals in the received signal processing section 404 and signal measurement in the measurement section 405.

The control section 401 obtains downlink control signals (signals transmitted on the PDCCH/EPDCCH) and a downlink data signal (a signal transmitted on the PDSCH) transmitted from the radio base station 10, from the received signal processing section 404. The control section 401 controls generation of an uplink control signal (e.g. a transmission acknowledgement signal (HARQ-ACK)) and an uplink data signal based on a result obtained by determining whether or not it is necessary to perform retransmission control on the downlink control signal and the downlink data signal.

Further, the control section 401 controls A-CSI transmission when the downlink control signal includes A-CSI transmission instruction information. The control section 401 can control a modulation order and/or PRBs applied to A-CSI transmission according to the number of serving cells for which the A-CSI transmission is instructed and/or an index (I_{MCS}) specified in a bit field related to a modulation and coding scheme of the downlink control information. The first modulation order defined in advance or the second modulation order equal to or higher than the first modulation order can be selected for the modulation order.

For example, the control section 401 applies the first modulation order (e.g. Qₘ=2) when the number of serving cells whose A-CSI is fed back is a predetermined value or less and/or an MCS index is the first index (e.g. I_{MCS}=29). Further, the control section 401 applies the second modulation order and/or the number of resource blocks larger than a predetermined number when the number of serving cells is larger than a predetermined value and/or an MCS index is the second index (e.g. I_{MCS}=30 or 31).

Furthermore, the control section 401 can determine the second modulation order based on higher layer signaling and/or the MCS index (I_{MCS}). For example, a case is assumed where a plurality of MCS indices (I_{MCS}s) is classified into the first index group and the second index group. In this case, the control section 401 can determine the second modulation order based on a modulation order associated with an MCS index included in the second index group.

Alternatively, the control section 401 may use as the second modulation order a modulation order associated with an MCS index included in the lastly received index group among MCS indices included in the first index group obtained by receiving the downlink control information. In this regard, the first index group can be composed of the MCS indices 0 to 28 that uplink data (UL-SCH) is mainly applied to, and the second index group can be composed of other MCS indices 29 to 31.

Alternatively, the control section 401 can control transmission of channel state information of different cell sets based on a serving cell that receives the downlink control information including the A-CSI transmission instruction (see FIGS. 6 and 7).

The transmission signal generating section 402 generates an uplink signal (such as an uplink control signal, an uplink data signal and an uplink reference signal) based on an instruction from the control section 401, and outputs the uplink signal to the mapping section 403. The transmission signal generating section 402 can be composed of a signal generator, a signal generation circuit and a signal generating apparatus described based on the common knowledge in the technical field according to the present invention.

For example, the transmission signal generating section 402 generates a transmission acknowledgement signal (HARQ-ACK) and an uplink control signal related to Channel State Information (CSI) based on, for example, the instruction from the control section 401. The transmission signal generating section 402 can determine a modulation order (modulation scheme) and the number of PRBs applied to transmit channel state information, according to the instruction from the control section 401. Further, the transmission signal generating section 402 generates an uplink data signal based on the instruction from the control section 401. When, for example, the downlink control signal notified from the radio base station 10 includes an UL grant, the control section 401 instructs the transmission signal generating section 402 to generate an uplink data signal.

The mapping section 403 maps the uplink signal generated by the transmission signal generating section 402, on radio resources based on the instruction from the control section 401, and outputs the uplink signal to the transmission/reception section 203. The mapping section 403 can be composed of a mapper, a mapping circuit or a mapping apparatus described based on the common knowledge in the technical field according to the present invention.

The received signal processing section 404 performs reception processing (e.g. demapping, demodulation and decoding) on the received signal input from each transmission/reception section 203. In this regard, the received signal is, for example, a downlink signal (such as a downlink control signal, a downlink data signal and a downlink reference signal) transmitted from the radio base station 10. The received signal processing section 404 can be composed of a signal processor, a signal processing circuit or a signal processing apparatus described based on the common knowledge in the technical field according to the present invention. Further, the received signal processing section 404 can configure the reception section according to the present invention.

The received signal processing section 404 outputs information decoded by the reception processing to the control section 401. The received signal processing section 404 outputs, for example, broadcast information, system information, RRC signaling and a DCI to the control section 401. Further, the received signal processing section 404 outputs the received signal and the signal after the reception processing to the measurement section 405.

The measurement section 405 performs measurement related to the received signal. The measurement section 405 can be composed of a measurement instrument, a measurement circuit or a measurement apparatus described based on the common knowledge in the technical field according to the present invention. The measurement section 405 may measure, for example, received power (e.g. RSRP), received quality (e.g. RSRQ) and a channel state of the received signals. The measurement section 405 may output a measurement result to the control section 401.

The block diagrams used to describe the Embodiment illustrate blocks in function units. These function blocks (components) are realized by an arbitrary combination of hardware and software. Further, means for realizing each function block is not limited in particular. That is, each function block may be realized by one physically jointed apparatus or may be realized by a plurality of apparatuses formed by connecting two or more physically separate apparatuses by wires or by radio.

For example, part or all of the functions of the radio base station 10 and the user terminal 20 may be realized by using hardware such as an ASIC (Application Specific Integrated Circuit), a PLD (Programmable Logic Device) and a FPGA (Field Programmable Gate Array). Further, the radio base station 10 and the user terminal 20 may be realized by a computer apparatus including a processor (CPU: Central Processing Unit), a network connection communication interface, a memory, and a computer-readable storage medium that stores programs. That is, the radio base stations and the user terminal according to one Embodiment of the present invention may function as a computer that performs processing of the radio communication method according to the present invention.

In this regard, the processor and the memory are connected by a bus that communicates information. Further, the computer-readable recording medium is, for example, a storage medium such as a flexible disk, a magnetooptical disk, a ROM (Read Only Memory), an EPROM (Erasable Programmable ROM), a CD-ROM (Compact Disc-ROM), a RAM (Random Access Memory) or a hard disk. Furthermore, the programs may be transmitted from a network via telecommunications lines. Still further, the radio base station 10 and the user terminal 20 may include an input apparatus such as an input key or an output apparatus such as a display.

Function configurations of the radio base station 10 and the user terminal 20 may be realized by the above-described hardware, may be realized by a software module executed by the processor or may be realized by a combination of both. The processor causes an operating system to operate and control the entire user terminal. Further, the processor reads programs, a software module or data from the storage medium out to the memory, and executes various types of processing according to the program, the software module or the data.

In this regard, the programs need to be programs that cause the computer to execute respective operations described in the above Embodiment. For example, the control section 401 of the user terminal 20 may be realized by a control program stored in the memory and operated by the processor or other function blocks may be realized likewise, too.

Further, software and instructions may be transmitted and received via transmission media. When, for example, the software is transmitted from websites, servers or other remote sources by using wired techniques such as coaxial cables, optical fiber cables, twisted pairs and digital subscriber lines (DSL) and/or radio techniques such as infrared rays, radio waves and microwaves, these wired techniques and/or radio technique are included in a definition of the transmission media.

In this regard, each term that is described in this Description and/or is necessary to understand this Description may be replaced with terms having identical or similar meanings. For example, a radio resource may be indicated by an index. Further, a channel and/or a symbol may be a signal (signaling). Furthermore, a signal may be a message. Still further, a Component Carrier (CC) may be called a carrier frequency and a cell.

Each Aspect/Embodiment described in this Description may be used alone, may be used in combination or may be switched and used when carried out. Further, notification of predetermined information (e.g. notification of “being X”) is not only explicitly performed but also may be implicitly performed (e.g. this predetermined information is not notified).

Notification of information is not limited to the Aspects/Embodiment described in this Description and may be performed by other methods. For example, the notification of the information may be performed by physical layer signaling (e.g. DCI (Downlink Control Information), UCI (Uplink Control Information)), higher layer signaling (e.g. RRC (Radio Resource Control) signaling, MAC (Medium Access Control) signaling, broadcast information (MIB (Master Information Block) and SIB (System Information Block)), other signals and combinations thereof. Further, the RRC signaling may be, for example, a RRC connection setup message or a RRC connection reconfiguration message.

The pieces of information and the signals described in this Description may be represented by using one of various different techniques. For example, the data, the instructions, the commands, the pieces of information, the signals, the bits, the symbols and the chips mentioned in the above description may be represented by voltages, currents, electromagnetic waves, magnetic fields or magnetic particles, optical fields, photons or arbitrary combinations thereof.

Each Aspect/Embodiment described in this Description may be applied to LTE (Long Term Evolution), LTE-A (LTE-Advanced), SUPER 3G, IMT-Advanced, 4G, 5G, FRA (Future Radio Access), CDMA2000, UMB (Ultra Mobile Broadband), IEEE 802.11 (Wi-Fi), IEEE 802.16 (WiMAX), IEEE 802.20, UWB (Ultra-WideBand), Bluetooth (registered trademark), systems that use other appropriate systems and/or next-generation systems that are enhanced based on these systems.

Orders of the processing procedures, the sequences and the flowchart of each Aspect/Embodiment described in this Description may be rearranged unless contradictions arise. For example, the method described in this Description presents various step elements in an exemplary order and is not limited to the presented specific order.

As described above, the present invention is specifically described, but it is obvious to a person skilled in the art that the present invention is not limited to the Embodiment described in the Description. The present invention is capable of being carried into practice as modified and changed aspects without departing from the subject matter and scope of the present invention defined by the descriptions of the scope of the claims. Accordingly, the description of the Description is intended for illustrative explanation, and do not have any restrictive meaning to the present invention.

The present application is based on Japanese Patent Application No. 2015-099439 filed on May 14, 2015, entire content of which is expressly incorporated by reference herein.

1. A user terminal comprising:
a reception section that receives downlink control information including information related to an instruction of transmission of aperiodic channel state information; and
a control section that controls the transmission of the aperiodic channel state information,
wherein the control section controls the transmission of the aperiodic channel state information by selecting a first modulation order or a second modulation order according to a number of serving cells and/or an index, the first modulation order being defined in advance, the second modulation order being equal to or higher than the first modulation order, the serving cells being serving cells for which the transmission of the aperiodic channel state information is instructed, and the index being related to a modulation and coding scheme included in the downlink control information.

2. The user terminal according to claim 1, wherein the control section determines the second modulation order based on higher layer signaling and/or the index.

3. The user terminal according to claim 1, wherein the control section applies the first modulation order and transmits the aperiodic channel state information when the number of serving cells is a predetermined value or less and/or the index is a first index, and controls the transmission of the aperiodic channel state information that the second modulation order and/or a number of resource blocks larger than a predetermined value are applied to when the number of serving cells is larger than the predetermined value and/or the index is a second index.

4. The user terminal according to claim 1, wherein
a plurality of indices related to the modulation and coding scheme is classified into a first index group and a second index group, and
the control section determines the second modulation order based on a modulation order associated with an index included in the second index group.

5. The user terminal according to claim 1, wherein
a plurality of indices related to the modulation and coding scheme is classified into a first index group and a second index group, and
the control section uses a modulation order as the second modulation order, the modulation order being associated with an index included in a lastly received first index group among indices included in the first index group obtained by receiving the downlink control information.

6. The user terminal according to claim 4, wherein the first index group is configured by indices 0 to 28, and the second index group is configured by 29 to 31.

7. The user terminal according to claim 1, wherein the control section transmits the aperiodic channel state information by using a physical uplink shared channel (PUSCH) that an uplink shared channel (UL-SCH) is not allocated to.

8. The user terminal according to claim 1, wherein the control section controls transmission of channel state information of different cell sets based on a serving cell that receives the downlink control information including the information related to the instruction of the transmission of the aperiodic channel state information.

9. A radio base station that communicates with a user terminal that can connect to a plurality of cells, the radio base station comprising:
a transmission section that transmits downlink control information including information related to an instruction of transmission of aperiodic channel state information; and
a reception section that receives aperiodic channel state information transmitted from the user terminal,
wherein the reception section receives the aperiodic channel state information, the aperiodic channel state information being applied a first modulation order or a second modulation order according to a number of serving cells and/or an index, the first modulation order being defined in advance, the second modulation order being equal to or higher than the first modulation order, the serving cells being serving cells for which the transmission of the aperiodic channel state information is instructed, and the index being related to a modulation and coding scheme included in the downlink control information.

10. A radio communication method of a user terminal that can connect to a plurality of cells, the radio communication method comprising:
receiving downlink control information including information related to an instruction of transmission of aperiodic channel state information; and
transmitting the aperiodic channel state information by selecting a first modulation order or a second modulation order according to a number of serving cells and/or an index, the first modulation order being defined in advance, the second modulation order being equal to or higher than the first modulation order, the serving cells being serving cells for which the transmission of the aperiodic channel state information is instructed, and the index being related to a modulation and coding scheme included in the downlink control information.

11. The user terminal according to claim 2, wherein the control section applies the first modulation order and transmits the aperiodic channel state information when the number of serving cells is a predetermined value or less and/or the index is a first index, and controls the transmission of the aperiodic channel state information that the second modulation order and/or a number of resource blocks larger than a predetermined value are applied to when the number of serving cells is larger than the predetermined value and/or the index is a second index.

12. The user terminal according to claim 2, wherein a plurality of indices related to the modulation and coding scheme is classified into a first index group and a second index group, and the control section determines the second modulation order based on a modulation order associated with an index included in the second index group.

13. The user terminal according to claim 3, wherein a plurality of indices related to the modulation and coding scheme is classified into a first index group and a second index group, and the control section determines the second modulation order based on a modulation order associated with an index included in the second index group.

14. The user terminal according to claim 2, wherein a plurality of indices related to the modulation and coding scheme is classified into a first index group and a second index group, and the control section uses a modulation order as the second modulation order, the modulation order being associated with an index included in a lastly received first index group among indices included in the first index group obtained by receiving the downlink control information.

15. The user terminal according to claim 3, wherein a plurality of indices related to the modulation and coding scheme is classified into a first index group and a second index group, and the control section uses a modulation order as the second modulation order, the modulation order being associated with an index included in a lastly received first index group among indices included in the first index group obtained by receiving the downlink control information.

16. The user terminal according to claim 5, wherein the first index group is configured by indices 0 to 28, and the second index group is configured by 29 to 31.
